(19) United States
(12) Patent Application Publication
(10) Pub. No.: US 2020/0156317 A1
(43) Pub. Date: May 21, 2020

(54) Improved System for Additive Manufacturing

(71) Applicant: STRUCTO PTE LTD, Singapore (SG)

(72) Inventors: Hubertus Theodorus Petrus Van Esbroek, Singapore (SG); Boyle Suwono, Singapore (SG); Kah Fai Chin, Singapore (SG); Devansh Sharma, Singapore (SG); Siu Hon Lam, Singapore (SG)

(21) Appl. No.: 16/615,296

(22) PCT Filed: May 22, 2018
(86) PCT No.: PCT/SG2018/050246

§ 371 Date: Nov. 20, 2019

(30) Foreign Application Priority Data
May 22, 2017 (GB) 1708188.6

(51) Int. Cl. B29C 64/245; B33Y 30/00

(52) U.S. Cl. CPC B29C 64/245; B33Y 30/00

(57) ABSTRACT

An additive manufacturing device arranged to produce a part, comprising: a printer bed; a platform engaged to said printer bed, said platform arranged to receive the part on a surface of said platform; wherein said platform is arranged to at least partially disengage from said printer bed.

### FIELD OF THE INVENTION

The invention relates to an additive manufacturing device and, in particular, a printer bed, arranged to receive a manufactured part created by such a device.

### BACKGROUND

Existing additive manufacturing devices, such as a stereolithographic additive manufacturing device as disclosed in WO 2015/072921, the contents of which are incorporated herein by reference, allow large objects to be printed at high speeds using additive manufacturing processes. In many additive manufacturing processes including, but not limited to, Stereo-lithography (SLA) and Masked Stereolithography (MSLA) processes, the manufactured part is deposited to a platform of a printer bed. After the additive process is completed, it is necessary to remove the part from the platform, before it can be processed further or immediately used. The removal process of part(s) from the platform is often difficult and labour intensive because of the considerable adhesion forces bonding the part to the platform. Depending on the geometry of the printed parts, the removal process may even damage the parts, for instance, thin member parts cracking or big parts permanently deformed and remain out of shape.

### SUMMARY OF THE INVENTION

In a first aspect, the invention provides an additive manufacturing device arranged to produce a part, comprising: a printer bed; a platform engaged to said printer bed, said platform arranged to receive the part on a surface of said platform; wherein said platform is arranged to at least partially disengage from said printer bed.

Accordingly, by having a platform that is at least partially separable and then providing a means of delaminating the part from the platform, the stress concentration established by the delamination allows the part to be readily removed without causing damage to the part through an excessive application of shear force to the part.

In one embodiment, the means of delamination may include deforming the platform to promote the stress concentration. In an alternative embodiment, the platform may be a single use item. In a further embodiment, the single use platform may be frangible so as to permit the platform to be fractured so as to break the platform away from the part. In a different embodiment, the printer bed may be of a highly differing coefficient of thermal expansion such that it expands/contract much more than the printed part, thus removing the part easily.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A, 1B and 1C are isometric views of a platform having a magnetic attachment to a printer bed according to one embodiment of the present invention;

FIGS. 2A and 2B are isometric views of a platform having mechanical engagement to a printer bed according to a further embodiment of the present invention;

FIGS. 3A and 3B are isometric views of a platform engaged to the printer bed through adhesion according to a further embodiment of the present invention;

FIG. 4 includes sequential steps of the engagement of the platform to the bed and subsequent removal of the part according to a further embodiment of the present invention;

FIG. 5 is an isometric view of a platform in vacuum engagement with the printer bed according to a further embodiment of the present invention;

FIG. 6 includes sequential step of a part being removed from a platform using an ejector pin according to one embodiment of the present invention;

FIG. 7A shows the platform secured to the pneumatically engaged arrangement by sliding joints before removal of the part.

FIG. 7B shows the flexing of the platform during removal of part.

### DETAILED DESCRIPTION

As mentioned, the invention seeks to solve the problem of a manufactured part(s) adhering to a platform(s) upon which the part(s) is/are produced. By having the platform(s) at least partially separable from the printer bed different techniques may be used to separate the part(s) from the platform(s), which may not be readily available as compared to the platform(s) being a unitary surface of the printer bed.

As mentioned, in one embodiment, the platform(s) may be delaminated from the part permitting the operator to secure the separated part without having to apply a shear force to the part in order to achieve separation.

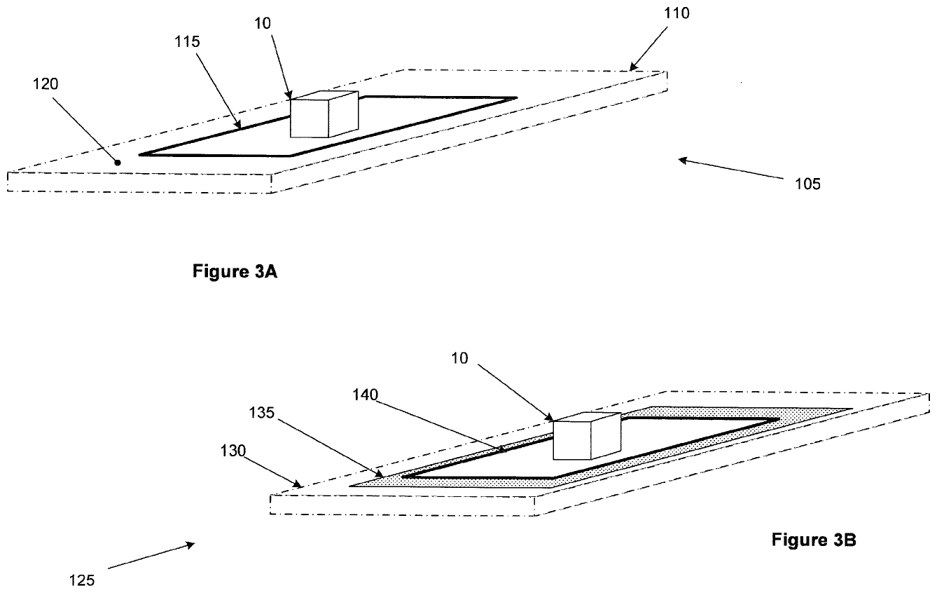

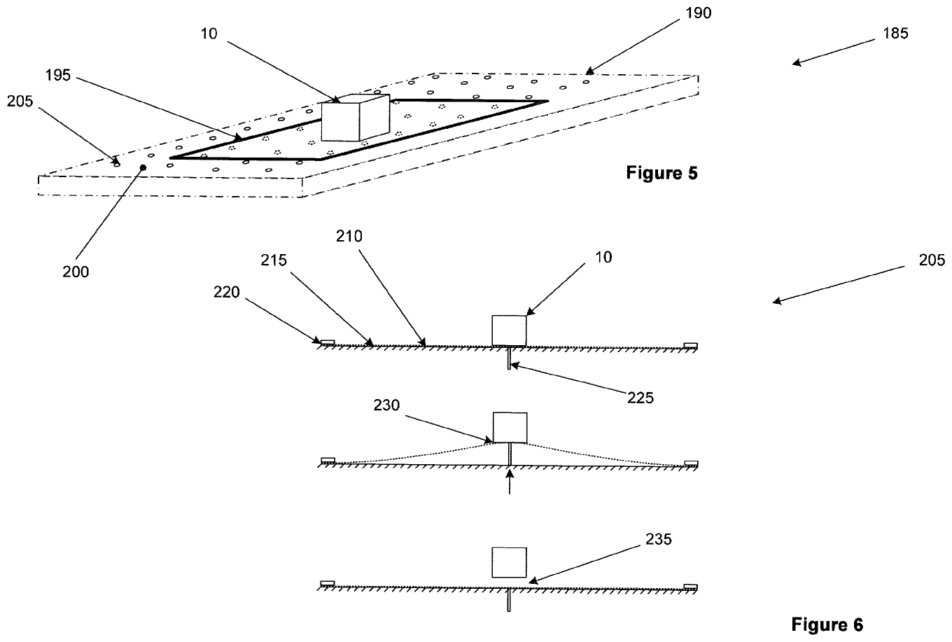

FIGS. 4 and 6 show processes by which this separation is achieved with the remaining figures providing embodiments of mounting the platform to the printer bed and so achieve the selective removal identified in FIGS. 4 and 6.

To outline the underlying method of the invention, the reader's attention is drawn to FIG. 4 showing sequential steps of the platform firstly being secured 145 to the printer bed 150. The additive manufacturing process creates a part on the platform at step 155 with the platform then being removed 160 from the printer bed. In a first alternative process, the platform, which may be naturally planar, and is subjected to a curvature 165 which leads to delamination between the effectively rigid part and flexible platform to achieve separation 170. The nature of the engagement between the platform and printer bed is the subject of the alternative embodiments to be discussed below.

The alternative process, once the platform is removed from the printer bed, depends upon the nature of the platform itself. At step 160 the platform may be naturally planar, however for the process of 175 the platform includes a camber. On release from the printer bed, the platform adopts its natural curvature, immediately leading to the development of a stress concentration between the part and the platform. The stress concentration then assists in the delamination of the part from the platform. For the planar platform, applying the curvature to the platform may be achieved in several ways including applying axial loads to the platform so as to buckle the platform. Alternatively, a curvature may be applied to the platform such as placing the platform on a curved template, and hold the platform in place as the part is delaminated. A further alternative shown in FIG. 6 as follows.

FIG. 6 shows a platform 210 which is only partially separable from the printer bed 215. In FIG. 6, the part 10 has been created on the platform 210 and is now ready for separation from the platform.

In this embodiment, the printer bed includes an ejector pin 225 which pushes the partially separable platform 210 upwards. It will be appreciated that the method shown in FIG. 6 may apply to both partially and fully separable platforms. For a fully separable platform, the edges of the platform may need to be restrained by any of the engagement methods described herein, with the embodiment of FIG. 6 using selectively removable blocks 220 such that the ejector pin applies a curvature to the platform 210. The curvature, as discussed, leads to a delamination 230 and subsequent separation 235 of the part from the platform.

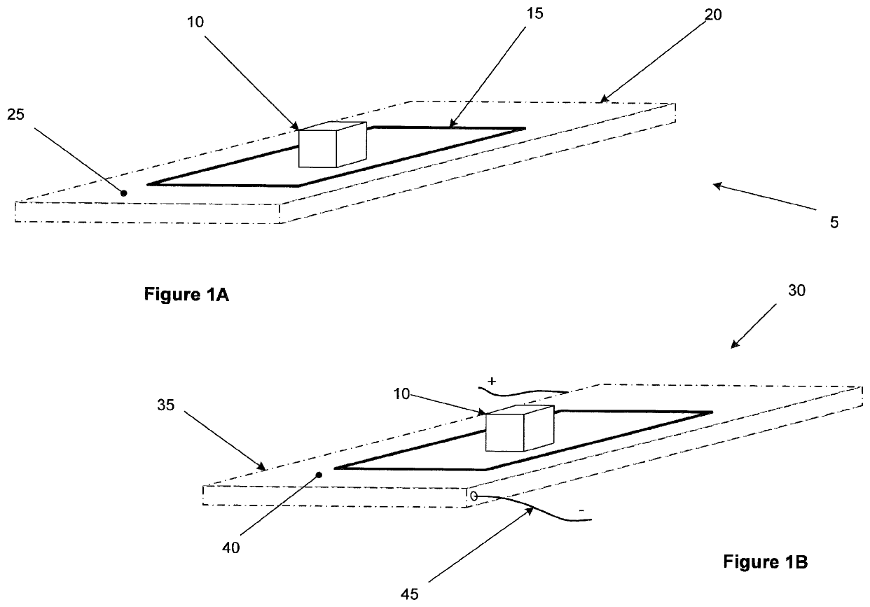

With reference to the various methods of engaging a fully separable platform with the printer bed and its subsequent removal, we turn to FIGS. 1A, 1B and 1C showing a magnetically engaged platform.

In FIG. 1A, an arrangement 5 includes the part 10 engaged with a platform 15 which in turn is engaged with a surface 25 of a printer bed 20. In this case the printer bed includes permanent magnets either embedded within the printer bed or as a layer forming the surface 25. The number, or extent, of the permanent magnets will depend upon the degree of adhesion required between the platform and printer bed. As the permanent magnets cannot be switched off, a tab 23 (shown in FIG. 1C) may be provided in the platform to aid in initiating separation of the platform from the surface 25.

It will be appreciated that initiation of the separation could be achieved in a number of different ways including a ridge or projection in the platform or the printer bed 20 preventing complete engagement between the platform and printer bed, and so providing an available point to initiate the separation. For instance, the tabs may be replaced by projections or other convenient means to grip the platform.

FIG. 1B shows an alternative arrangement 30 whereby the printer bed 35 includes in the surface 40, either as a layer or as an array of discrete points, electro-magnets powered by an electrical supply 45. This has the advantage of being able to selectively turn off the electro-magnets and thus assist in separating the platform from the printer bed 35.

The nature of the platform for the embodiments of FIGS. 1A, 1B and 1C clearly require the platform to include a ferromagnetic material to be engaged by the magnetic surface. In an alternate embodiment, the platform may be a spring steel or the like, that will retain its flexibility and shape after many cycles or rounds of bending and/or stretching. In subsequent embodiments, the platform, however, could be made from a series of different materials and not necessarily limited to a metallic material, including polymers such as, but not limited to, Polypropylene, PET, PE etc.

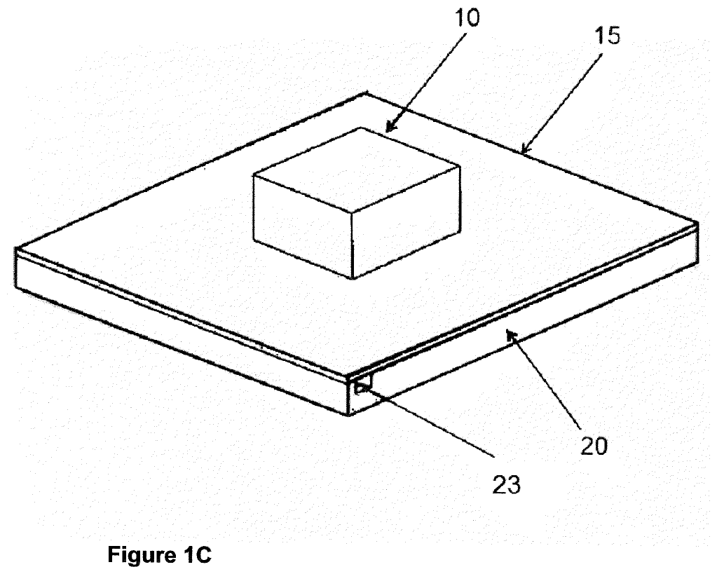

FIGS. 2A and 2B show mechanical means by which the platform is engaged with the printer bed. For FIG. 2A, the platform 65 is fixed through clips 70 on the surface 60 of the printer bed 55, which are arranged to move from a first, unengaged position to a second engaged position. Thus, to remove the platform it merely needs to be unclipped for easy removal. The clips may be electronically actuated or simply spring loaded. The clips may, not only restrain the platform, but bias it against the printer bed to maintain planarity. The terms clips and latches may be used interchangeably.

FIG. 2B shows an alternative mechanical arrangement 75 whereby the surface 85 of the printer bed 80 includes studs 90 which engage with apertures 95 in the platform 100. The studs may engage with the apertures as a screw threaded nut or press fit into the apertures or any of a number of means by which the platform can be selectively fixed to the surface 85 of the printer bed 80. Alternatively, the platform may include studs which fit into apertures within the printer bed.

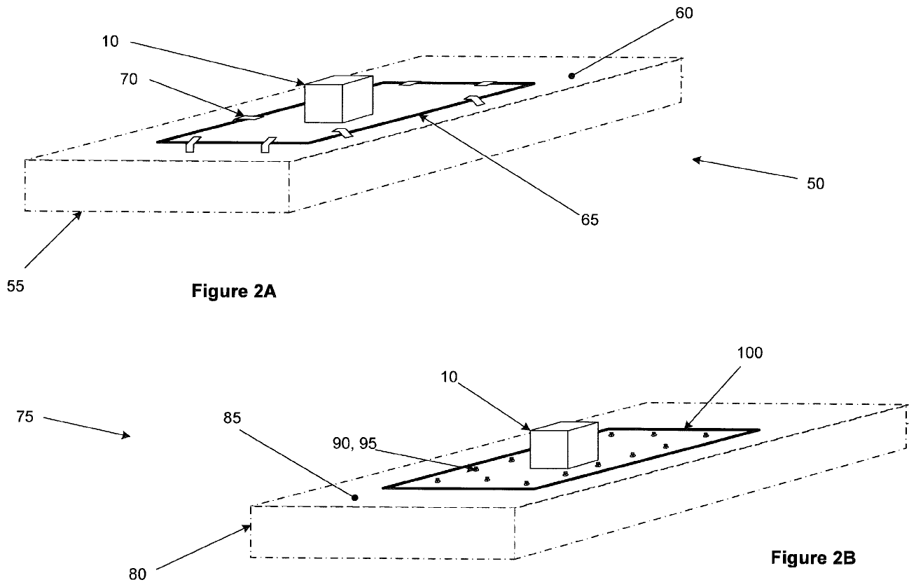

FIGS. 3A and 3B show an alternative arrangement of the platform adhesively engaged with the printer bed. The first arrangement 105 in FIG. 3A shows the platform 115 fixed using a reusable adhesive surface applied to the printer bed. The adhesive should be strong enough that it sufficiently resists separation of the platform from the printer bed. Yet it should also be removable given a correct force that is applied from a feature like tab 23 to initiate such separation.

For FIG. 3B rather than the entire surface having the adhesive, a replaceable layer 135 may be used. As mentioned the adhesive may be a reusable adhesive. Alternatively, the adhesive, either at the surface or a dedicated layer, may be a consumable that requires replacing for the manufacture of each part. The adhesive layer can be a membrane that sticks to the platform with enough adherence force such that during the printing process, the membrane adheres completely to the platform and can be peeled from the edge, allowing the printed parts to be easily removed from the membrane.

In a further alternative, the adhesive surface or layer may be subject to deterioration through heat or other means such as UV light, water solubility or other solvent (such as organic solvent but may also include different types of solvents made widely available). Preferably, the material of the part will be unreactive with the selected solvent. To this end, immersing the printer bed in hot water or applying a hot air jet or steam may be sufficient to break down the adhesive layer for removal of the platform. It follows that any application of heat, either as a hot bath, hot air or steam, must be balanced against preventing any damage to the part itself. It will be appreciated that several adhesives may be used for the embodiment that have deterioration or melting temperatures fractionally above ambient room temperature.

A quasi-adhesive/mechanical engagement may also be used, such as in the form of a hook-and-loop mechanism (such as Velcro™) could also be used as a reusable “adhesive”.

It will be appreciated that any of the embodiments directed to adhesive engagement may adopt either a surface application or a discrete layer on the surface. However, discrete adhesive points may also be useful, particularly around the periphery of the platform to aid in removal as compared to having to peel the platform directly from a more widely distributed layer.

A further alternative to the temperature dependent deterioration of the adhesive is the use of a binding agent such as hot melt or other means of bonding the platform to the printer bed. In this embodiment, the bonding agent may have a considerably higher rate of thermal expansion than the platform, and so delamination through differential expansion for relatively small changes in temperature may be sufficient to delaminate the part from the platform. Alternatively, it is also possible that the platform is able to expand and contract considerably more than the printed parts which stick to the platform. After the printing process is completed, the platform(s) is exposed to high temperature (for example, a hot water bath). The significant difference in the thermal expansion/contraction causes the printed parts to get removed from the platform. The opposite can also be applied, where the platform(s) is exposed to a low temperature, resulting in a similar outcome.

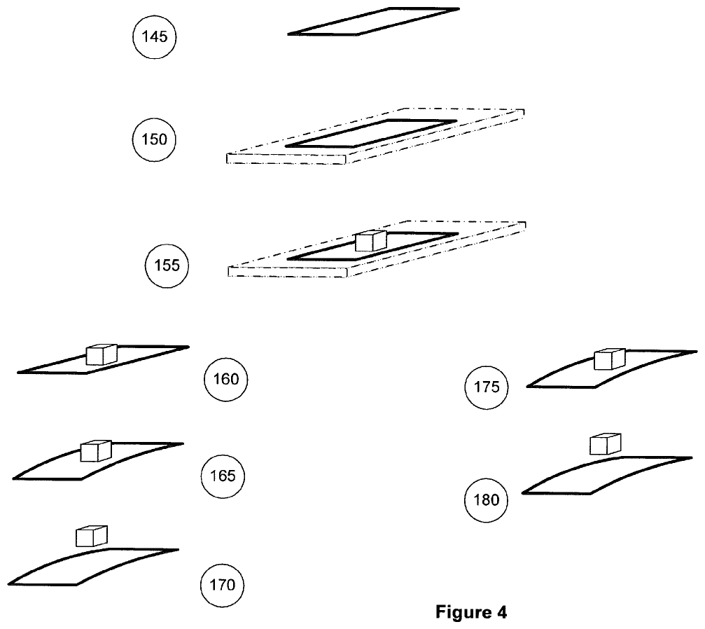

FIG. 5 shows a pneumatically engaged arrangement, whereby the platform 195 is engaged with the surface 200 of a printer bed 190 through a vacuum seal. The surface 200 may include an array of vacuum apertures 205 in communication with a vacuum source to selectively engage the platform 195. In order to release the platform the vacuum source merely needs to be switched off for easy removal. Though FIG. 5 shows the vacuum apertures 205 extending beyond the platform, this is for illustration purposes only. For the most efficient use of the vacuum engagement the platform may be designed to cover all of the available vacuum apertures so as not to undermine the efficiency of the vacuum seal.

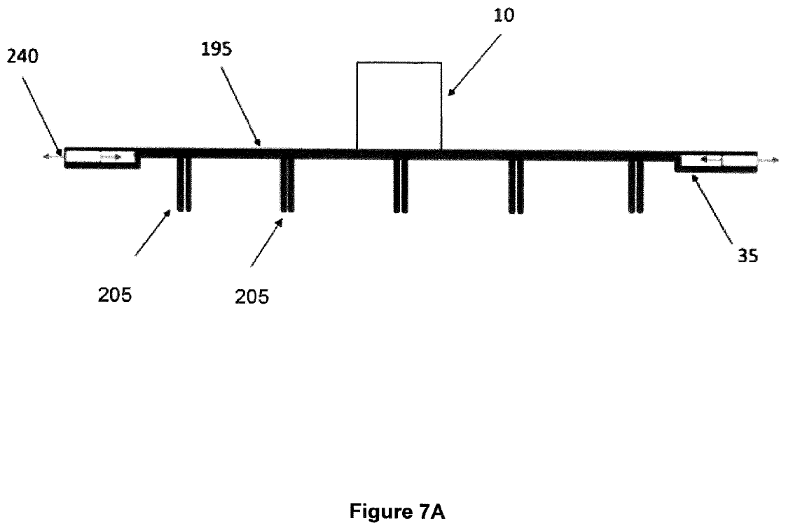

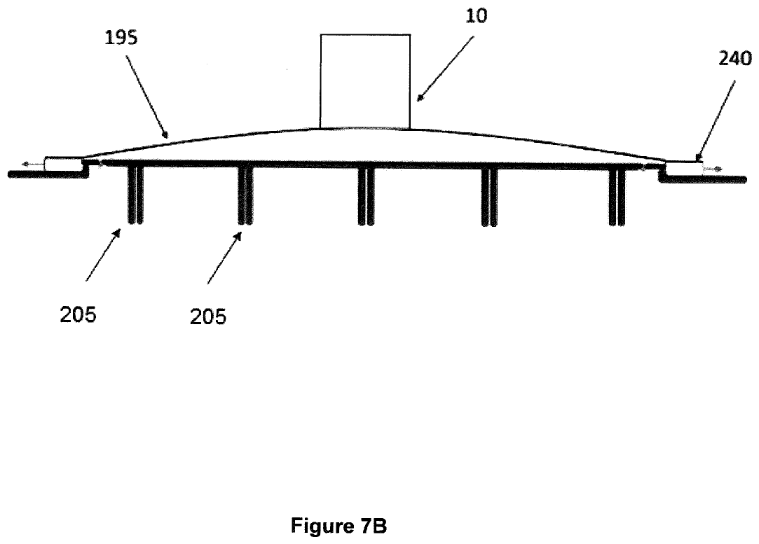

Before removal of the part 10 as shown in FIG. 7A, the platform 195 is secured to the pneumatically engaged arrangement by sliding joints 240, allowing the platform to bend but remaining attached to the mechanism. During removal as shown in FIG. 7B, the suction force can then be stopped, and the platform is pushed in the middle by pneumatic actuation or other means, thereby flexing it. The part 10 will then be dropped or released from the platform.

Another embodiment of this method is to have the sliding joints similar as described above, and having it actuated sideways by pneumatic actuation or other means. When printing process is done and suction force is stopped, the sliding joints can be actuated, creating a flex to the platform. The parts will then drop from the platform.

Although particular embodiments have been described and illustrated herein, it will be appreciated by those of ordinary skill in the art that various modifications and combinations of features of the above embodiments are possible such as the removal of part(s) using the combination of pneumatic and magnetic methods. There is also a possibility that the platform can encompass the following characteristics such as shape variation, e.g. outlines (rectangular, square, circular, etc.), perforated vs. non-perforated, flat vs. naturally bent, etc, and/or having thickness variation, e.g. thin (such as 1 mm [0.04 in] or even less), or thick. The material of the platform(s) can also vary, e.g., hard and/or sturdy material such as spring steel or the like, flexible, stretchy, etc. The platform may also retain its flexibility and shape after many cycles or rounds of bending and/or stretching. The platform can feature various designs to achieve certain desired characteristic, e.g. unidirectional bending, uniform directional bending, etc.

1. An additive manufacturing device arranged to produce a part, comprising
a printer bed;
a platform engaged to said printer bed, said platform arranged to receive the part on a surface of said platform;
wherein said platform is arranged to at least partially disengage from said printer bed.

2. The additive manufacturing device according to claim 1, wherein the platform is arranged to selectively separate from said printer bed.

3. The additive manufacturing device according to claim 1, wherein the platform is magnetically engaged with the printer bed.

4. The additive manufacturing device according to claim 3, wherein the printer bed includes a surface having at least one permanent magnet and said platform includes a ferromagnetic material.

5. The additive manufacturing device according to claim 3, wherein the printer bed includes a surface having at least one selectively operable electro-magnet and said platform includes a ferromagnetic material.

6. The additive manufacturing device according to claim 1, wherein the platform is adhesively engaged with the printer bed.

7. The additive manufacturing device according to claim 6, wherein the printer bed includes a surface with at least a portion including an adhesive.

8. The additive manufacturing device according to claim 1, wherein the platform is mechanically engaged with the printer bed.

9. The additive manufacturing device according to claim 8, wherein the printer bed includes elements arranged to selectively engage the platform.

10. The additive manufacturing device according to claim 9, wherein the elements include clips or latches arrangement to move from a first position to a second position, whereby the second position corresponds to engagement with the platform.

11. The additive manufacturing device according to claim 9, wherein the elements include studs on the surface of the printer bed, said studs corresponding to engagable apertures in both the platform and/or printer bed.

12. The additive manufacturing device according to claim 1, wherein the platform is pneumatically engaged with the printer bed.

13. The additive manufacturing device according to claim 12, wherein the surface of the printer bed includes an array of vacuum apertures in fluid communication with a vacuum source.

14. The additive manufacturing device according to claim 1, wherein the platform further comprises at least one biasing member, the biasing member arranged to allow the platform to retain flexibility and/or shape after repeated cycles of bending and/or stretching.

15. The additive manufacturing device according to claim 6, wherein the engagement is through discrete adhesive points.

16. The additive manufacturing device according to claim 7, wherein adhesive has deterioration or melting temperatures fractionally above ambient room temperature.

17. The additive manufacturing device according to claim 7, wherein the adhesive comprises a binding agent with a considerably higher rate of thermal expansion or contraction than the platform.

18. The additive manufacturing device according to claim 12, wherein the platform is engaged with the printer bed by sliding joints.

19. The additive manufacturing device according to claim 18, wherein the sliding joints are actuable sideways to flex the platform.

20. The additive manufacturing device according to claim 1, wherein the printer bed comprises an array of ejector pins arranged to actuate against the platform and consequently apply a curvature to the platform.
